(19) United States
(12) Patent Application Publication
(10) Pub. No.: US 2016/0070442 A1
(43) Pub. Date: Mar. 10, 2016

(54) USER INTERFACE FOR IDENTITY SWITCHING

(71) Applicant: salesforce.com, inc., San Francisco, CA (US)

(72) Inventors: Glenn Sorrentino, San Francisco, CA (US); Darshil Vipul Vora, San Francisco, CA (US); Bharath Hariharan, San Francisco, CA (US)

(21) Appl. No.: 14/664,231

(22) Filed: Mar. 20, 2015

Related U.S. Application Data
(60) Provisional application No. 62/048,378, filed on Sep. 10, 2014.

(51) Int. Cl. G06F 3/0484; H04L 29/06

(52) U.S. Cl. CPC G06F 3/04842; H04L 65/403

(57) ABSTRACT

In some cases, a person may have more than one identity that can be used for various purposes, such as sharing content online. For example, different identities might include identities on various social networks, email addresses, work or personal identities, etc. This disclosure provides various techniques that may allow a user to select which identity is to be used. For example, a user may first select one identity for sharing an item of content, and then select a different identity.

### CROSS-REFERENCE TO RELATED APPLICATIONS

This application claims priority to U.S. Provisional Application Ser. No. 62/048,378, filed on Sep. 10, 2014, which is incorporated by reference herein in its entirety.

### BACKGROUND

1. Technical Field

This disclosure relates to the sharing of content (e.g., the online sharing of content), and more particularly to users who have more than one identity from which content may be shared.

2. Description of the Related Art

In recent years, there has been a proliferation of online content sharing services. For example, Facebook®, Twitter®, various other social networking services, and even email can all be considered to be online content sharing services. This has led to a corresponding proliferation in the number of identities than an individual may have that are usable for sharing content (and for various other activities). It has thus become difficult for individuals to manage and share content with the appropriate identity.

### BRIEF DESCRIPTION OF THE DRAWINGS

FIG. 1 is a block diagram illustrating an embodiment of this disclosure.

FIGS. 2A-2B show an embodiment of a user interface for selecting an identity according to one embodiment.

FIG. 3 is a process flow according to one embodiment.

FIG. 4 is a process flow according to another embodiment.

FIGS. 5A-5G show an embodiment of a user interface for sharing content from an external source, according to one embodiment.

FIG. 6 is a process flow for sharing content from an external source, according to one embodiment.

FIG. 7A-7E show an embodiment of a user interface for sharing content from within an application, according to one embodiment.

FIG. 8 is a process flow for sharing content from within an application, according to one embodiment.

FIG. 9 is a block diagram illustrating a computing device, according to one embodiment.

### DETAILED DESCRIPTION

It is not uncommon for users to have multiple accounts and/or multiple identities, such as multiple email accounts, multiple usernames, etc. For instance, a user may prefer to keep at least two identities, one for business use and one for personal use, rather than intermixing business and personal communications. Further, the modern digital reality may often be even more complex. A user may have multiple personal identities for different activities, such as a first identity smitty-dude for gaming, a second identity smitty for social networks, a third identity @smitty77 for Twitter®, a fourth identity for some other reason, etc. A user may also have multiple business identities, such as a first identity companyname for the user's role as a representative or owner of the company, a second identity username@companydomain for the user primary business identity, a third identity customer-service@companydomain that the user uses to review and respond to customer inquiries, etc. Such multiple identities may thus include identities from different organizations (e.g., Twitter® vs. an email host). Finally, a user may have some or all of his multiple identities active on his computer or mobile device at the same time.

For purposes of this disclosure, the term “identity” is used to refer to information that identifies an individual or user within a particular information-sharing context. Examples of information-sharing contexts include email, websites, applications, and the like. Accordingly, examples of identities include, without limitation, email addresses, Twitter® handles, Facebook® names, website user names, message board handles, and the like. It is quite common for a user to have identities for professional use, and other identities for personal use. A user may also have multiple identities within a particular information-sharing context. For example, within the Salesforce1® application, different communities may be associated with different customers. Thus by choosing to share a content item with a particular community, the user is choosing to share it with a subset of all of the users of a particular information-sharing context (the Salesforce1® application, in this example).

The presence of multiple active identities may cause problems for the user if he or she shares a content item (e.g., by uploading a post or sending an email) from the wrong identity. Accordingly, it would be desirable to allow the user to easily control the identity with which a content item is associated.

Currently, if a user sharing a content item realizes in time that the wrong identity is selected, she can rectify the situation by first copying the link to the content item (e.g., to the clipboard), then exiting the first identity (which often means exiting the application), then re-opening the application using a different identity, and then posting the copied link. This can be a frustrating and time-consuming experience for the user. Thus, it would be advantageous to have a feature that allows for quick switching of identities.

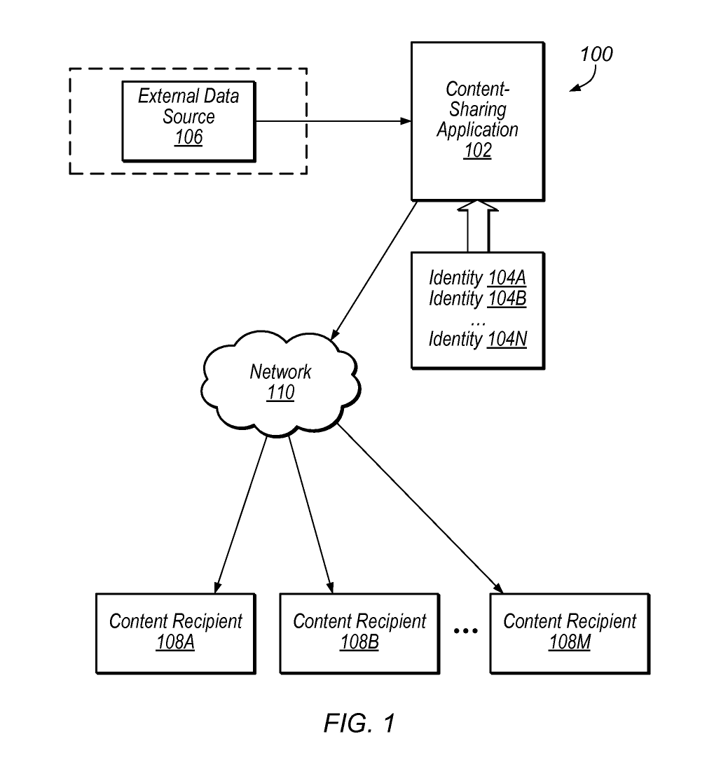

Turning now to FIG. 1, a block diagram of system 100 is shown. It should be noted that various elements shown in FIG. 1 (and other process flows in this disclosure) may be used in conjunction with any of the computer systems, servers, mobile devices, other apparatuses, elements, or components disclosed herein or known in the art, among other devices. In various embodiments, some of elements of process flows shown may be performed concurrently, in a different order than shown, or may even be omitted. Additional process flow elements not shown may also be performed as appropriate or desired.

In system 100, content-sharing application 102 allows a user to share a content item with a selected audience. The content item may in some cases be newly created, or it may be a content item which was discovered within content-sharing application 102 (e.g., after having been shared by another user, etc.). In some embodiments, it may be a content item from external data source 106, such as a different application or site.

Regardless of the source of the content item, it is commonly the case that the user wishes to share it with one or more of content recipients 108A-108M. Because the user has various identities 104A-104N, the content-sharing application receives a selection of which of the identities should be used to share the content item. The content item is then shared via network 110 with the desired recipients.

According to some embodiments, process flows according to this disclosure may include steps that are carried out on a mobile device. In other embodiments, a user may initiate certain aspects from a mobile device, but some steps may be carried out on a server computer system. The mobile device and the server computer system in such embodiments may be connected via a network such as the Internet. For example, in one embodiment, a user interface may be presented to a user via a mobile device, and a database of identities may be stored on a server in communication with the mobile device. In another embodiment, the database of identities may be stored locally at the mobile device. In some embodiments, a database may be used to store the items of content themselves. One of ordinary skill in the art with the benefit of this disclosure will understand that various types of database or other storage technologies may be used in accordance with this disclosure. One of ordinary skill in the art with the benefit of this disclosure will also understand that the teachings herein are applicable to various types of situations in which sharing content is a goal.

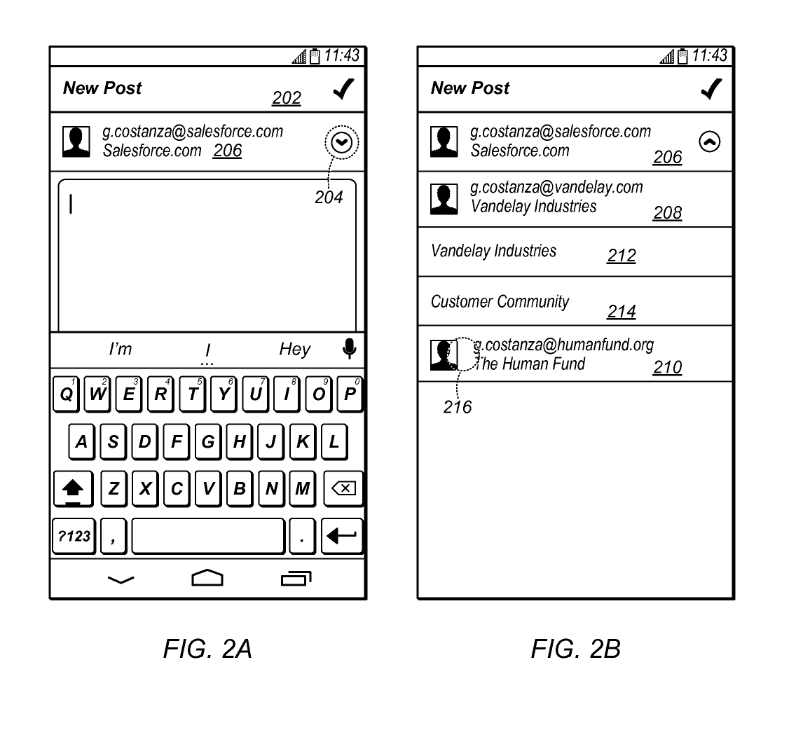

Turning now to FIGS. 2A-2B, an embodiment of a user interface for selecting an identity for content sharing is shown. As shown in FIG. 2A, a user has elected to share a content item (in this instance, new post 202). The user has more than one possible identity from which the content item could be shared. For example, one identity 206 is shown as already selected in FIG. 2A. As shown, identity 206 is in this instance an email address associated with a given domain (salesforce.com). Identity 206 may in some embodiments be a default identity for the user. In other embodiments, the user may have simply previously selected identity 206. In either case, button 204 allows the user the option of switching to a different identity.

If the user selects (e.g., clicks or taps on) button 204, a dropdown menu as shown in FIG. 2B may be presented. In FIG. 2B, the user has three identities that may be selected: identity 206 (which is currently selected by default), identity 208, and identity 210. Additionally, identity 208 has multiple “communities” associated with it. For purposes of this disclosure, a community refers to a group of potential recipients for the content item within a particular information-sharing context. For example, if the user were to choose to share new post 202 via identity 208, he or she could also select to share it with community 212 and/or community 214 in this embodiment. In some embodiments, a particular community may be the default recipient group for identity 208. In this instance, the user selects identity 210 by selecting user interface element 216.

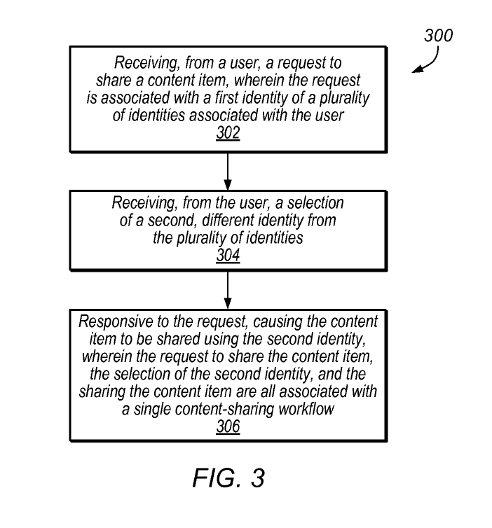

Turning now to FIG. 3, process flow 300 for identity selection according to one embodiment is shown. Process flow 300 may be carried out by any suitable computing system, such as a mobile device, a server computer system, or some other apparatus. Flow begins at step 302.

At step 302, a request to share a content item is received from a user. The content item may in some embodiments be a newly created content item such as new post 202, discussed above. In other embodiments, the content item may be a pre-existing content item, such as an article on a website, a map location, a text, contact information, a photo, a video, an audio clip, or the like. At step 302, it is noted that the request is associated with a first identity out of a plurality of identities associated with the user. For example, the first identity may be a default identity that the computing system has associated with the user. In other embodiments, the first identity may instead be a particular identity that the user has previously selected. The plurality of identities may in one embodiment be different identities all associated with the same information-sharing context (e.g., a particular application, etc.). Flow proceeds to step 304.

At step 304, a selection of a second, different identity from the plurality of identities is received. For example, this selection could be received via a user interface element such as what was shown in FIGS. 2A-2B. Various other possibilities for receiving this selection will also be apparent to one of ordinary skill in the art with the benefit of this disclosure. Flow proceeds to step 306.

At step 306, the computing system causes the content item to be shared via the second identity. It is noted that the request to share the content item, the selection of the second identity, and the sharing are all associated with a single content-sharing workflow.

For purposes of this disclosure, the term “content-sharing workflow” refers to a series of steps performed via one or more user interface elements to share a content item. For example, a series of user interface elements that permit a user to select a content item to be shared via an application, select an identity with which to share the item, and then share the content item via the application would constitute a single content-sharing workflow. If, on the other hand, a user begins a content-sharing workflow, cancels the operation, and then re-commences sharing, this would constitute two different content-sharing workflows. For example, one or more dialog boxes might be user interface elements used in some cases to allow the user to share the content item. Thus FIGS. 2A-2B may be said to depict a single content-sharing workflow (or in some embodiments, a portion of a single content-sharing workflow), and the dropdown menu shown in FIG. 2B would be a portion of that same single content-sharing workflow. Step 306 specifies that only a single content-sharing workflow is used in this instance. Flow ends at step 306.

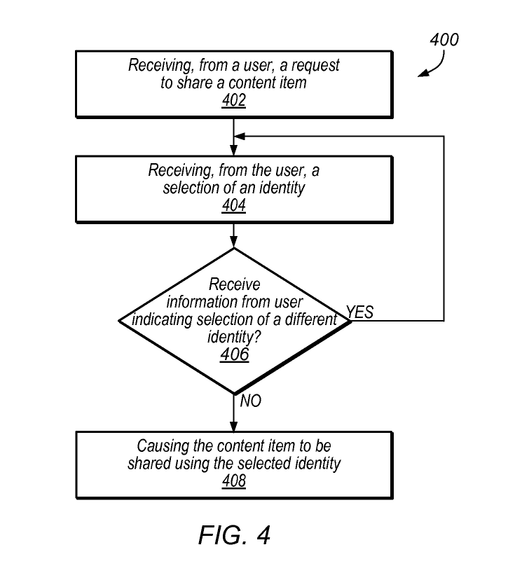

Turning now to FIG. 4, another process flow 400 is shown, which illustrates an example of a user selecting different identities. Flow starts at step 402.

At step 402, a request to share a content item is received from a user. In this example, no default identity is selected for the user. Instead, at step 404, a selection of an identity is received from the user. For example, the user may be prompted with a list of available identities, and the selection may be based on that list. Flow proceeds to decision block 406.

At decision block 406, it is determined whether or not the selected identity is the correct one, or whether information indicating a selection of a different entity has been received from the user. For example, the user could be prompted to confirm that the selected identity is correct. In other embodiments, a user interface element could be displayed to the user to offer the user the option of selecting a different identity. If the selected identity is not correct at decision block 406, then flow loops back to step 404, and the user is able to select a different identity. If the selected identity is correct, then flow proceeds to step 408.

At step 408, the content is shared via the selected identity. Flow ends at step 408.

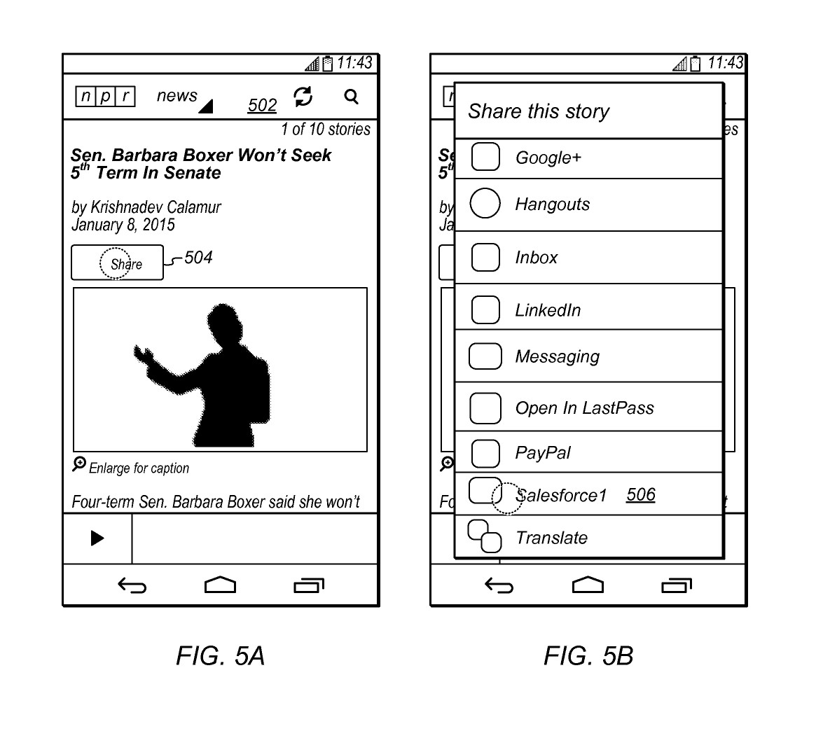

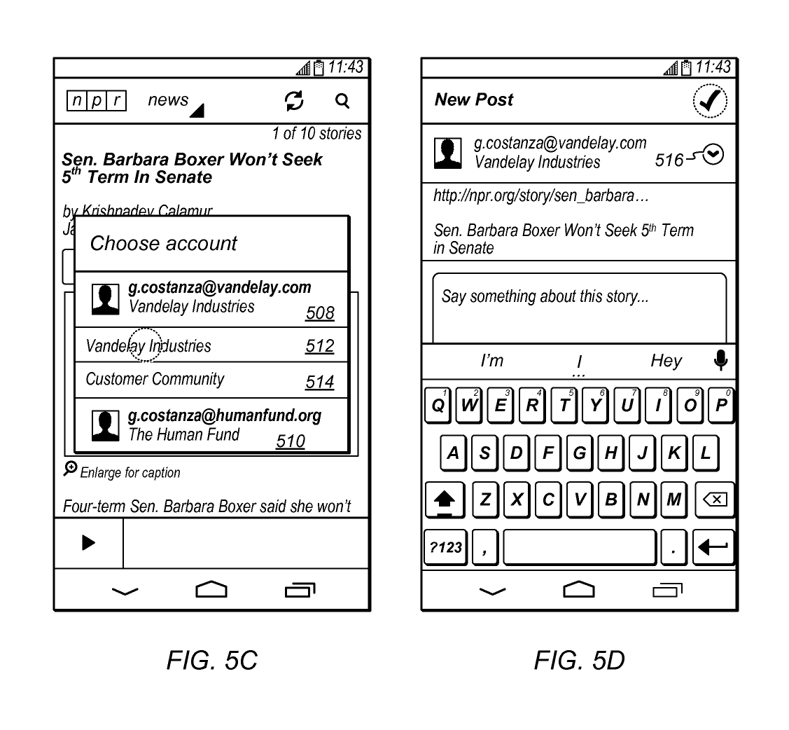

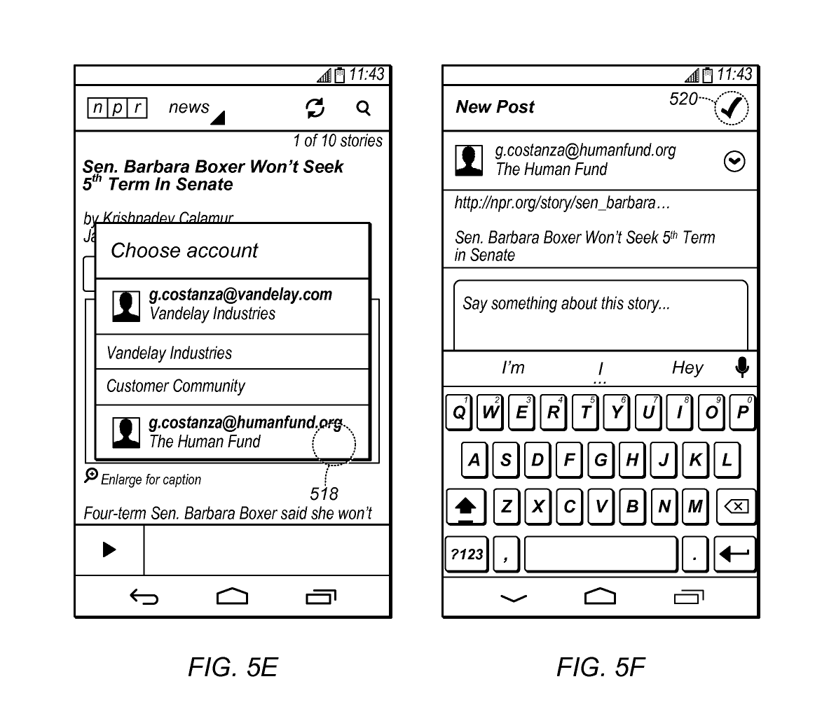

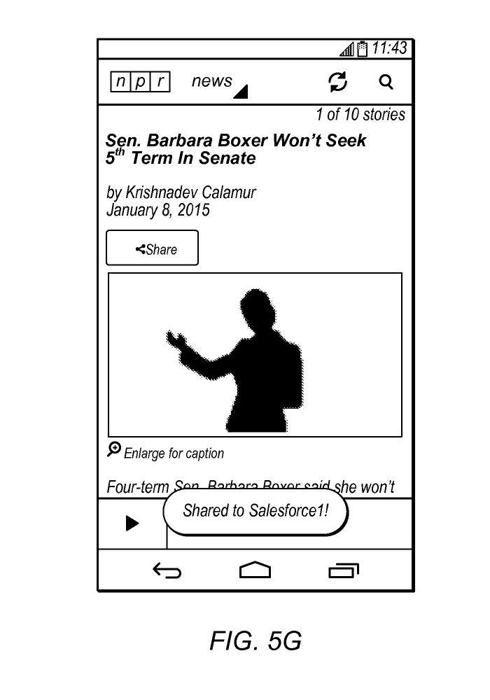

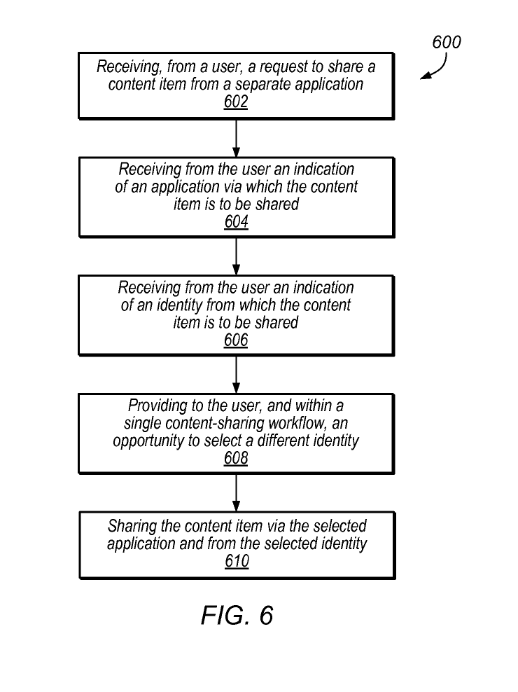

FIGS. 5A-5G and FIG. 6 provide details about an embodiment in which content is shared from an external application.

Turning now to FIGS. 5A-5G, an embodiment of a user interface for sharing content from an external application is shown. As shown in FIG. 5A, a user has found a content item within external application 502. The user selects share button 504 to initiate a content-sharing workflow.

At FIG. 5B, a user interface element is shown that allows the user to select which content-sharing application is to be used to share the content item. The user in this instance selects content-sharing application 506.

At FIG. 5C, a user interface element (a dropdown menu in this instance) is shown that allows the user to select which identity to use to share the content item. The user in this case selects identity 508. As noted above with regard to FIG. 2B, in some instances the user may also select a particular community with which to share the content item. In this instance, the user has the option of selecting either community 512 or community 514, which are both associated with identity 508. The user selects community 512. (In some embodiments, the selection of community may be independent of the selection of identity.)

At FIG. 5D, the user may decide that the content item should be shared from a different identity, rather than identity 508. Accordingly, the user may select user interface element 516. This may bring the user back to the dropdown menu of FIG. 5C, as shown in FIG. 5E. The user may then select a different identity, in this case identity 510, by selecting user interface element 518.

At FIG. 5F, the content-sharing workflow continues, and as shown, the selected identity has been changed from “g.costanza@salesforce.com” (i.e., identity 508) to “g.costanza@humanfund.org” (i.e., identity 510). The user interface element shown in FIG. 5F may also allow the user to add a comment to the content item before sharing it. Once the user is satisfied with the content item to be shared, and the identity from which it should be shared, he or she may select user interface element 520. A successful content sharing message is shown at FIG. 5G. The user is thus able to easily select a first identity, and then change to a different identity, all from within a single content-sharing workflow.

It should also be noted that in some embodiments, within a single content-sharing workflow, the user may share the same content item from multiple identities. For example, the user might select a first identity, complete the sharing process, and then be given an opportunity (e.g., via a “share again” button not shown in FIGS. 5A-5G) to choose other identities from which the content item is to be shared. This aspect may be useful, for example, in situations where a user has a content item that may be of interest to multiple different groups that are associated with different identities.

It should also be noted that while FIGS. 5A-5G show the selection of different identities within a single information-sharing context (the Salesforce1® application in this case), this disclosure need not be limited to such embodiments. In some cases, a selection of an identity from a completely different information-sharing context may be selected, and the content item may be shared in that different information-sharing context. For example, a user may start in the Salesforce1® application and begin a content-sharing workflow. The user may then decide that he or she would rather share the content item from Facebook®. The original information-sharing context (the Salesforce1® application) may then allow the user to select a Facebook® identity from which to share the content item. The actual sharing may then be effected in various ways, such as via the Facebook® API, or by making a suitable call to the Facebook® application, etc.

Turning now to FIG. 6, process flow 600 is shown for sharing content from an external source. Flow begins at step 602.

At step 602, a request is received from a user to share a content item. Various types of content items have already been described above, and this step may include any suitable type of content item. The request to share may be received at a mobile device or a server computer system, for example via an external application. Flow proceeds to step 604.

At step 604, an indication is received from the user of which application should be used to share the content item. For example, in some embodiments, an operating system-level dialog box may be used to provide the user with options for the available sharing applications. In some embodiments, this functionality may be built into an external application. Flow proceeds to step 606.

At step 606, an indication is received from the user of which identity (e.g., which identity within the context of the selected application) should be used to share the content item. Once the user has selected an identity, flow proceeds to step 608.

At step 608, an opportunity is provided to the user to select a different identity. For example, a button or other user interface element may be provided to the user to activate a list of possible identities. In some embodiments, a confirmation user interface element may be used to confirm that the user has already selected the correct identity. Once the user has selected a new identity or confirmed the existing identity, flow proceeds to step 610.

At step 610, the content item is shared via the selected application and from the selected identity. Flow ends at step 610.

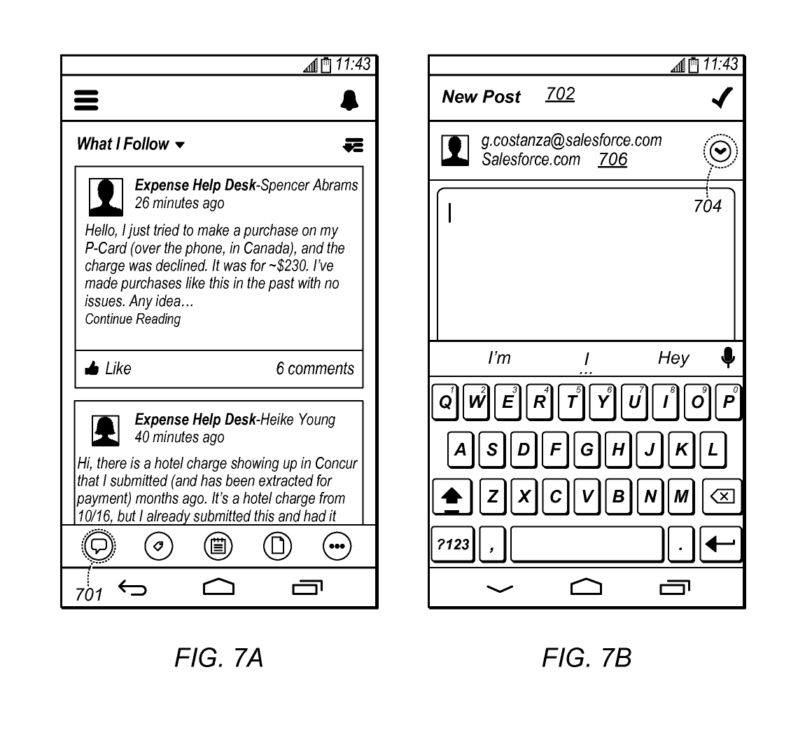

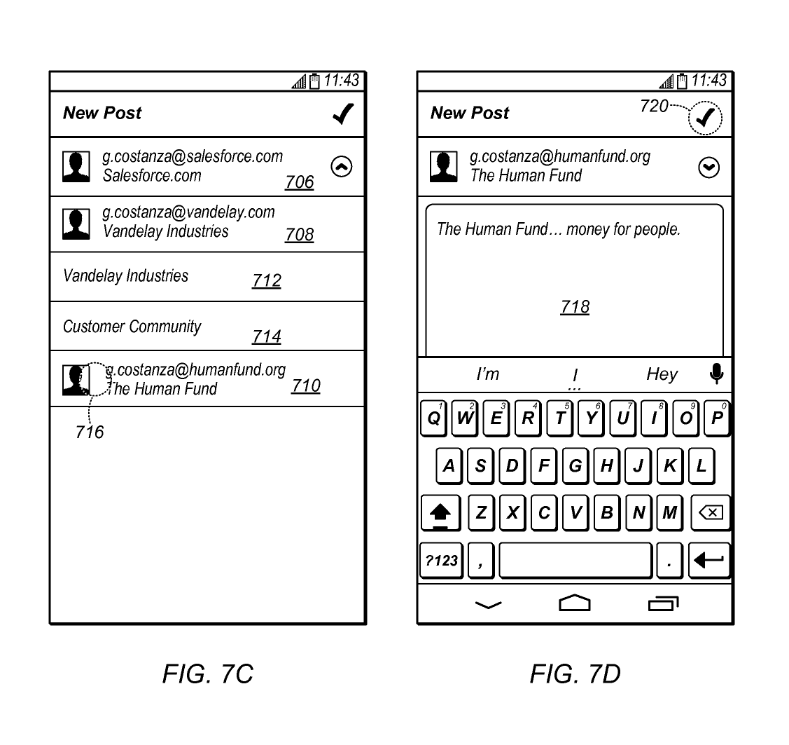

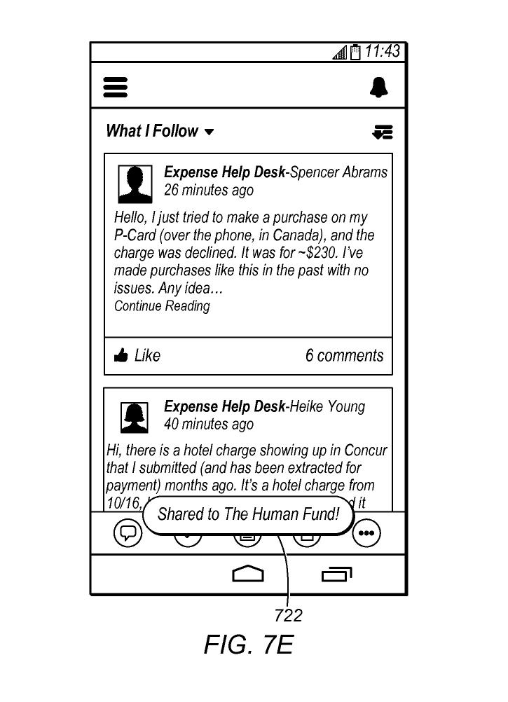

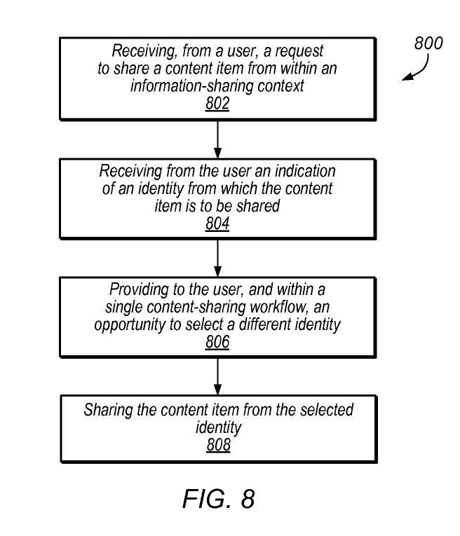

As noted above, in some embodiments, the content item to be shared may not come from an external application. That is, in some cases, it may be unnecessary to consider the question of which application is to be used for sharing the content item, because the content item may be coming from the desired application. FIGS. 7A-7E and FIG. 8 provide details about an embodiment in which content is shared from within a particular application, and they may be contrasted with the discussion above of FIGS. 5A-5G and FIG. 6.

Turning now to FIGS. 7A-7E, an example of a content-sharing workflow in this context is provided.

As shown in FIG. 7A, a user may be browsing existing content items within a content-sharing application. The user may elect to re-share one of these existing content items or create a new content item from within the content-sharing application. For example, a user might discover a content item when interacting with the content-sharing application as a first identity, but then decide to re-share the content item as a second, different identity.

In this instance, as shown in FIG. 7A, the user has elected to create a new content item (instead of re-sharing an existing content item) by selecting post button 701. As shown in FIG. 7B, the content-sharing application then creates new post 702, which can be filled out by the user. The user has more than one possible identity from which the content item may be shared. For example, one identity 706 is shown as already selected in FIG. 7A. As shown, identity 706 is in this instance an email address associated with a given domain (salesforce.com). Identity 706 may in some embodiments be a default identity for the user. In other embodiments, the user may have simply previously selected identity 706. In either case, button 704 allows the user the option of switching to a different identity.

If the user selects button 704, a dropdown menu as shown in FIG. 7C may be presented. In FIG. 7C, the user has three identities that may be selected: identity 706 (which is already selected), identity 708, and identity 710. Additionally, identity 708 has communities 712 and 714 associated with it. In this instance, the user selects identity 710 by selecting user interface element 716.

At FIG. 7C, the user enters text 718 which is to become new post 702. In some embodiments, the user may also include a URL, attach a photo, tag other users, etc. For simplicity, in this example, a plain text content item is shown. Once the user has created new post 702, the user confirms the sharing by selecting button 720. At FIG. 7E, confirmation 722 is shown to confirm that new post 702 has been successfully shared from the selected identity (and in some embodiments, to the selected community).

For the sake of brevity, some elements in this content-sharing workflow similar to those shown at FIGS. 5D and 5E are omitted in this example. One of ordinary skill in the art with the benefit of this disclosure will understand that those elements may apply in this situation as well, and that the user could use such user interface elements to make changes in the selected identity without leaving the single content-sharing workflow.

Turning now to FIG. 8, process flow 800 is shown for sharing content from within an application. Flow begins at step 802.

At step 802, a request is received from a user to share a content item. The content item may be an existing content item (e.g., something previously shared by another user), or it may be a newly created content item. The request to share may be received at a mobile device or a server computer system, for example via an external application. Flow proceeds to step 804.

At step 804, an indication is received from the user of which identity (e.g., which identity within the context of the selected application) should be used to share the content item. Once the user has selected an identity, flow proceeds to step 806.

At step 806, an opportunity is provided to the user to select a different identity. For example, a button or other user interface element may be provided to the user to activate a list of possible identities. In some embodiments, a confirmation user interface element may be used to confirm that the user has already selected the correct identity. Once the user has selected a new identity or confirmed the existing identity, flow proceeds to step 808.

At step 808, the content item is shared from the selected identity. Flow ends at step 808.

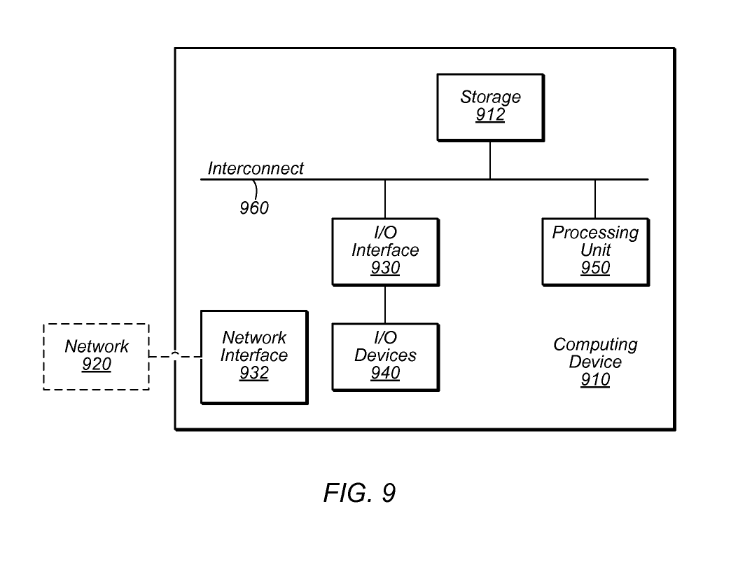

Turning now to FIG. 9, a block diagram of a computing device (which may also be referred to as a computing system) 910 is depicted, according to some embodiments. Computing device 910 may be used to implement various portions of this disclosure, such as the causing user interface elements to be displayed, for example. Computing device 910 is one example of a device that may be used as a mobile device, a server computer system, or any other computing system implementing portions of this disclosure.

Computing device 910 may be any suitable type of device, including, but not limited to, a personal computer system, desktop computer, laptop or notebook computer, mobile phone, mainframe computer system, web server, workstation, or network computer. As shown, computing device 910 includes processing unit 950, storage subsystem 912, input/output (I/O) interface 930 coupled via interconnect 960 (e.g., a system bus). I/O interface 930 may be coupled to one or more I/O devices 940. Computing device 910 further includes network interface 932, which may be coupled to network 920 for communications with, for example, other computing devices.

As described above, processing unit 950 includes one or more processors. In some embodiments, processing unit 950 includes one or more coprocessor units. In some embodiments, multiple instances of processing unit 950 may be coupled to interconnect 960. Processing unit 950 (or each processor within processing unit 950) may contain a cache or other form of on-board memory. In some embodiments, processing unit 950 may be implemented as a general-purpose processing unit, and in other embodiments it may be implemented as a special purpose processing unit (e.g., an ASIC). In general, computing device 910 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 912 is usable by processing unit 950 (e.g., to store instructions executable by and data used by processing unit 950). Storage subsystem 912 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 912 may consist solely of volatile memory in some embodiments. Storage subsystem 912 may store program instructions executable by computing device 910 using processing unit 950, including program instructions executable to cause computing device 910 to implement the various techniques disclosed herein.

I/O interface 930 may represent one or more interfaces and may be any of various types of interfaces configured to couple to and communicate with other devices, according to various embodiments. In some embodiments, I/O interface 930 is a bridge chip from a front-side to one or more back-side buses. I/O interface 930 may be coupled to one or more I/O devices 940 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component.

Although specific embodiments have been described above, these embodiments are not intended to limit the scope of the present disclosure (even where only a single embodiment is described with respect to a particular feature). Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Although some example embodiments are described as providing various advantages, any particular embodiment according to this disclosure may provide some, all, or even none of such advantages.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a processor; and
a storage device having computer instructions stored therein that are configured to cause the apparatus to perform operations comprising:
receiving, from a user, a request to share a content item, wherein the request is associated with a first identity from a plurality of identities that are associated with the user;
receiving, from the user, a selection of a second, different, identity from the plurality of identities; and
responsive to the request, sharing the content item using the second identity,
wherein the request to share the content item, the selection of the second identity, and the sharing the content item are all associated with a single content-sharing workflow.

2. The apparatus of claim 1, wherein the first and second identities are each associated with a single information-sharing context.

3. The apparatus of claim 2, wherein the information-sharing context is an application executable to share content.

4. The apparatus of claim 1, wherein the operations further comprise:
receiving, from the user, a selection of a group with which the content item is to be shared, the group being selected from a plurality of groups that are associated with the second identity.

5. The apparatus of claim 1, wherein a plurality of groups are associated with the second identity, and wherein the content item is shared with a default one of the plurality of groups.

6. The apparatus of claim 1, wherein the operations further comprise:
responsive to an additional request from the user and via the single content-sharing workflow, sharing the content item using the first identity.

7. The apparatus of claim 1, wherein the apparatus is further configured to:
receive, from the user, a selection of an application via which the content item is to be shared.

8. An article of manufacture including a non-transitory, computer-readable medium having instructions stored thereon that are configured to cause a computing device to perform operations comprising:
receiving, from a user, a request to share a content item, wherein the request is associated with a first identity from a plurality of identities that are associated with the user;
receiving, from the user, a selection of a second, different, identity from the plurality of identities; and
responsive to the request, causing the content item to be shared using the second identity,
wherein the request to share the content item, the selection of the second identity, and the sharing the content item are all associated with a single content-sharing workflow.

9. The article of claim 8, wherein the article is embodied within a mobile device associated with the user.

10. The article of claim 8, wherein the article is embodied within a server computer system.

11. The article of claim 10, wherein the server computer system is configured to receive the request and the selection from a mobile device associated with the user.

12. The article of claim 11, wherein the server computer system is configured to communicate with the mobile device via an Internet connection, and wherein the content item is shared via the Internet connection.

13. The article of claim 8, wherein the first identity is a default identity.

14. The article of claim 8, wherein the first identity is an identity selected by the user.

15. A method, comprising:
receiving, from a user, a request to share a content item, wherein the request is associated with a first identity from a plurality of identities that are associated with the user;
receiving, from the user, a selection of a second, different, identity from the plurality of identities; and
responsive to the request, causing the content item to be shared using the second identity,
wherein the request to share the content item, the selection of the second identity, and the sharing the content item are all associated with a single content-sharing workflow.

16. The method of claim 15, wherein the first identity and the second identity are associated with a single information-sharing context.

17. The method of claim 15, wherein the first identity and the second identity are associated with different information-sharing contexts.

18. The method of claim 15, further comprising:
receiving, from the user, a selection of a group with which the content item is to be shared, the group being selected from a plurality of groups that are associated with the second identity.

19. The method of claim 15, further comprising:
responsive to an additional request from the user, causing the content item to be shared using a third identity.

20. The method of claim 15, wherein the first and second identities are email addresses.
